(19) United States
(12) Patent Application Publication
(10) Pub. No.: US 2002/0047284 A1
(43) Pub. Date: Apr. 25, 2002

(54) Apparatus for wafer transportation

(76) Inventor: Yakov Katsman, Stoughton, MA (US)

Correspondence Address: Stephen M. De Klerk, Blakely, Sokoloff, Taylor & Zafman LLP, Seventh Floor, 12400 Wilshire Boulevard, Los Angeles, CA, 90025-1026, US

(21) Appl. No.: 09/848,383

(22) Filed: May 2, 2001

Related U.S. Application Data
(60) Provisional application No. 60/242,473, filed on Oct. 24, 2000.

(51) Int. Cl. B65G 7/12

(52) U.S. Cl. 294/27.1

(57) ABSTRACT

The invention relates to apparatus for wafer transportation. A handle assembly is engageable with a wafer transfer cassette and has a grip which allows for movement of the wafer transfer cassette. The handle assembly is profiled so as not to interfere with insertion of the cassette into certain apparatuses. The handle assembly is also profiled to allow for easy detachment when the wafer transfer cassette is in such an apparatus, and easy attachment to the wafer transfer cassette.

### CROSS-REFERENCE TO RELATED PATENT APPLICATIONS

Priority is claimed from U.S. Provisional patent application Ser. No. 60/242,473 filed on Oct. 24, 2000.

### BACKGROUND OF THE INVENTION

1). Field of the Invention

This invention relates to an apparatus for wafer transportation and an apparatus for handling a wafer.

2). Discussion of Related Art

Wafer transfer cassettes are used for transferring wafers from one location to another in a semiconductor fabrication environment. A plurality of wafers are downwardly inserted between sidewalls of a wafer transfer cassette. A base of the wafer transfer cassette supports a lower periphery of each wafer. Septa separate the wafers from one another so that they are spaced in an axial direction.

A handle assembly is then attached to the wafer transfer cassette. The handle assembly includes a grip which can be used for manually moving the wafer transfer cassette from location to location. Conventional handle assemblies do not allow for easily inserting a wafer transfer cassette into certain apparatuses. Conventional wafer transfer cassettes also do not provide for easy engagement with or disengagement from a wafer transfer cassette, especially when the wafer transfer cassette is located within certain apparatuses.

### BRIEF DESCRIPTION OF THE DRAWINGS

The invention is further described by way of examples with reference to the accompanying drawings wherein:

FIG. 1 is a perspective view of an apparatus for wafer transportation, according to an embodiment of the invention;

FIG. 2A is a side view illustrating a wafer transfer cassette and a handle assembly before engagement;

FIG. 2B is a view similar to FIG. 1A after the handle assembly is moved towards the wafer transfer cassette;

FIG. 2C is a view similar to FIG. 2B after the handle assembly is moved in an upward direction;

FIG. 2D is a view similar to FIG. 2C after the handle assembly is further elevated;

FIG. 3 is an end view of an apparatus for handling a wafer, according to an embodiment of the invention, which includes the apparatus of FIG. 1;

FIG. 4A is a view similar to FIG. 2D, illustrating how the wafer transfer cassette and handle assembly are inserted into a rotor of the apparatus shown in FIG. 3;

FIG. 4B is a view similar to FIG. 4A after the handle assembly is moved in a downward direction;

FIG. 4C is a view similar to FIG. 4B after the handle assembly is moved away from the wafer transfer cassette; and

FIG. 5 is a perspective view of an apparatus for wafer transportation, according to another embodiment of the invention.

### DETAILED DESCRIPTION OF THE INVENTION

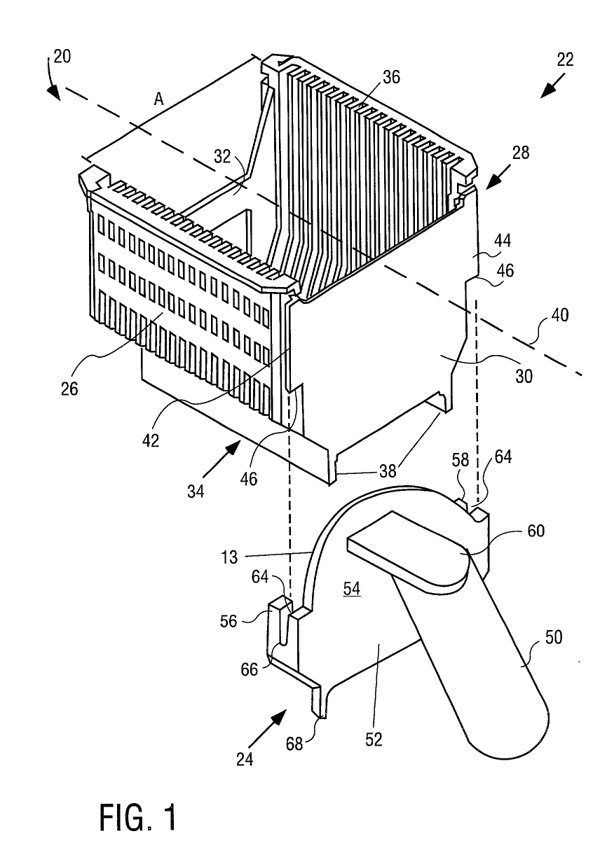

FIG. 1 of the accompanying drawings illustrates an apparatus 20 for wafer transportation, according to an embodiment of the invention, which includes a wafer transfer cassette 22, and a handle assembly 24.

The wafer transfer cassette 22 includes first and second sidewalls 26 and 28, first and second endwalls 30 and 32, a base 34, and septa 36. The sidewalls 26 and 28 and the endwalls 30 and 32 extend upward from the base 34. The septa 36 are located on inner surfaces of the sidewalls 26 and 28 and an upper surface of the base 34. Rail supports 38 extend downwardly from a lower surface of the base 34.

In use, wafers are downwardly inserted into the transfer cassette 22. Each wafer has a left edge against the sidewall 26, a right edge against the sidewall 28 and a lower edge supported by the base 38. The sidewalls 26 and 28 may for example be spaced from one another by about six inches, thereby allowing for wafers having diameters of six inches to be inserted between the sidewalls 26 and 28. The wafers are spaced from one another in a direction of an axis 40. The wafers are alternated by the septa 36. Each wafer is supported by two of the septa 36 on opposing sides of the wafer, and each septa 36 supports two wafers on the opposing sides of the septa 36.

The endwall 30 has lift formations 42 and 44 formed on opposing sides thereof. The endwall 30 together with the lift formations 42 and 44 form a lift structure which is secured to the sidewalls 26 and 28. The lift formation 42 extends to the left away from the axis 40 from a corner where the endwall 30 and the sidewall 26 meet. Similarly, the lift formation 44 extends to the right away from the axis 40 from a corner where the end wall 30 and the sidewall 28 meet. Each formation 42 and 44 has a respective lower surface 46.

The handle assembly 24 includes a grip 50 and an engagement structure 52. The engagement structure 52 includes a flange 54 and engagement formations 56 and 58. The flange 54 is shown in a vertical orientation.

A connection block 60 is secured to the flange 54. The grip 50 is secured to the connection block 60. The connection block 60 extends horizontally away from the flange 54 and the grip 50 extends downwardly and away from the flange 54. The grip 50 has an outer surface which can easily be held in a hand of the person. The grip 50 may be roughened or be coated with a material which reduces the likelihood of slip out of a hand of a person.

The formations 56 and 58 extend from the flange 54 to a side of a flange 54 opposing the grip 50. The formation 56 is located on the left of the grip 50 and the formation 58 is located on the right of the grip 50. Each formation 56 or 58 has a respective slot 64 formed downwardly into an upper surface thereof and terminating in a base surface 66.

Stands 68 extend downwardly from a lower edge of the flange 54. Lower edges of the stands 68 are located at a same elevation of a lower end of the grip 50 so that the handle assembly can be located on a horizontal surface with the flange 54 vertically oriented.

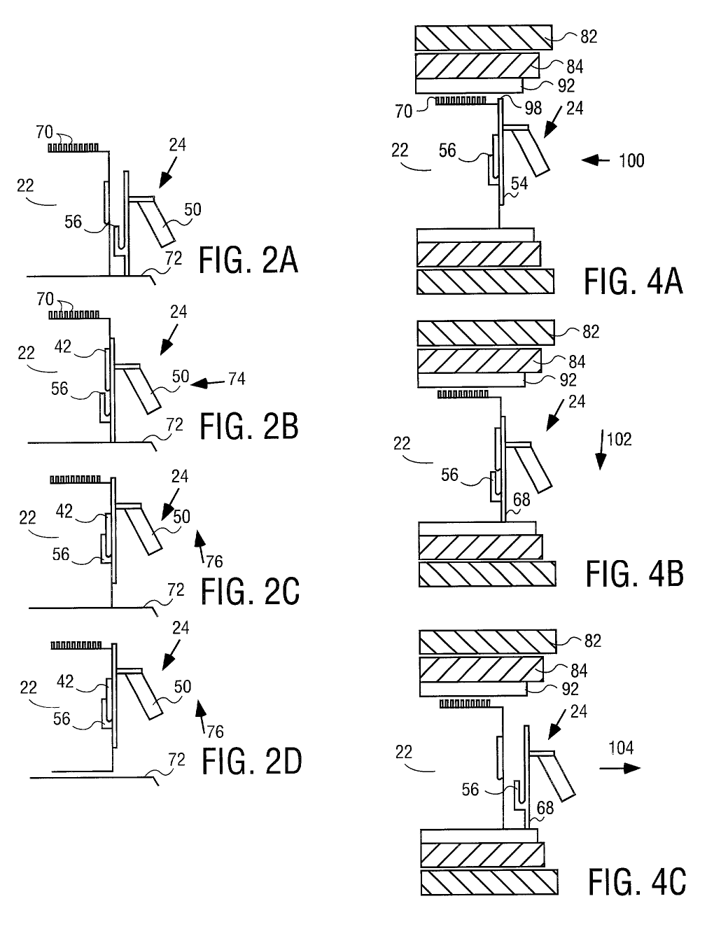

FIGS. 2A-D illustrate how the handle assembly 24 is used to engage with and elevate the wafer transfer cassette 22. As shown in FIG. 2A, the wafer transfer cassette 22 is loaded with wafers 70. Because the wafers 70 are circular, the upper edges thereof are located six inches above the base 34 of the wafer transfer cassette 22. Lower surfaces of the rail supports 38 are located on a horizontal surface 72. Lower surfaces of the stands 68 are also located on the horizontal surface 72 with a handle assembly 24 spaced from the wafer transfer cassette 22.

As shown in FIG. 2B, the handle assembly 24 is then moved in a direction 74 towards the wafer transfer cassette 22 into a preparatory position. The handle assembly 24 is moved by an operator holding onto the grip 50. Upper surfaces of the engagement formations 56 and 58 are located lower than lower surfaces of the lift formations 42 and 44 so that the engagement formations 56 and 58 move past the lift formations 42 and 44 without the need to lift the wafer transfer cassette 22.

As shown in FIG. 2C, the grip 50 is then used to elevate the handle assembly 24 in a direction 76 into a locked position. The lift formations 42 and 44 slide into the slots 64 of the engagement formations 56 and 58, respectively. The handle assembly 24 is elevated until the lower surfaces 46 contact the base surfaces 66.

As shown in FIG. 2D, the operator then further elevates the handle assembly 24 in the direction 76. The wafer transfer cassette 22 is elevated together with the handle assembly 24 in the direction 76. The operator can now use the grip 50 to move the transfer cassette 22 into another position.

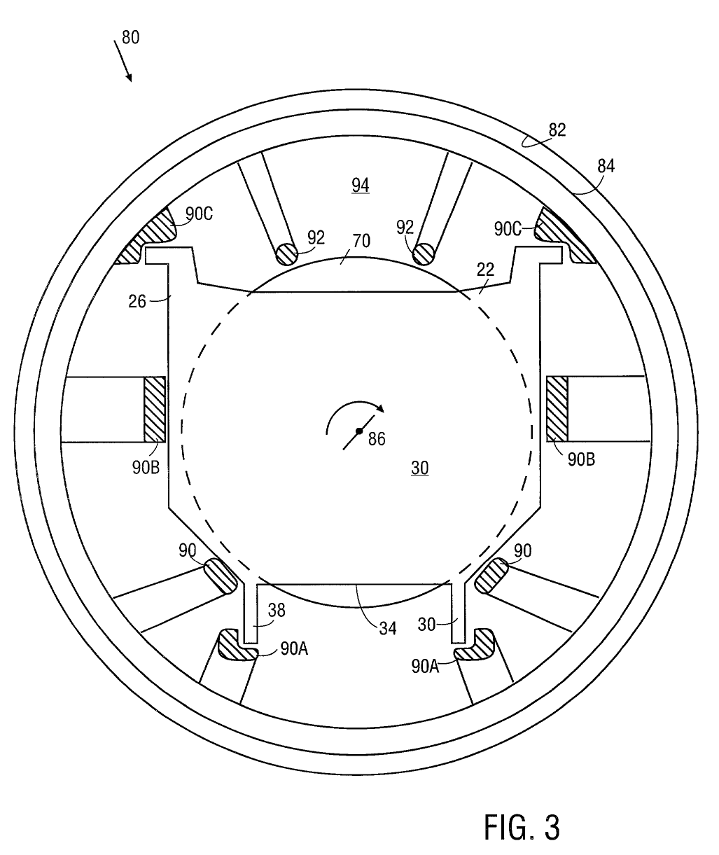

FIG. 3 illustrates an apparatus 80 for handling a wafer which, in addition to the transfer cassette 22 and the handle assembly 24, further includes a stator 82 and a rotor 84.

The stator 82 defines a cavity in which the rotor 84 is mounted. The rotor 84 is mounted to the stator 82 for rotation about an axis 86.

The apparatus 80 also includes transfer cassette support rods 90 and wafer support rods 92. The transfer cassette support rods 90 are positioned so that the wafer transfer cassette 22 is insertable, utilizing the grip 50, into an enclosure 94 defined in the rotor 84 and the wafer support rods 92 are then located above the wafers 70. The rail supports 38 are located on lower ones of the support rods 90A and the wafer transfer cassette 22 is then pushed so that the rail supports 38 slide along the lower support rods 90A. Side support rods 90B are located directly adjacent the side walls 26 and 28. Upper support rods 90C are located above and directly adjacent upper edges of the sidewalls 26 and 28. The wafer support rods 92 are located directly above and adjacent the wafers 70. The rods 90 and 92 are all mounted to the rotor 84 and all extend in a direction of the axis 86.

FIGS. 4A-C further illustrate how the handle assembly 24 is used for locating the wafer transfer cassette 22 inside the rotor 84. In FIG. 4A, an upper edge 98 of the flange 54 is located below upper edges of the wafers 70. The flange and the handle assembly 24 are thus insertable in a direction 100 below the wafer support rods 92 without the need for first moving the handle assembly 24 in a downward direction. In fact, an entire upper periphery of the flange 54 is dimensioned to be entirely within a profile projection of the wafers 70 and the transfer cassette 22 so as to be universally used for inserting the transfer cassette 22 and the wafers 70 into enclosures having not only the wafer support rods 92 but also other support rods and components located around the wafers 70 and upper edges of the transfer cassette 22. Side edges of the flange 54 and the engagement formations 56 and 58 are also located entirely within a projection of the wafer transfer cassette 22 so as to be insertable not only between the side rails 90B but also in between other components, used in other machines, located next to the sidewalls 26 and 28.

Referring now to FIG. 4B, the handle assembly 24 is disengaged from the wafer transfer cassette 22 by moving the handle assembly 24 in a downward direction 102 until lower surfaces of the stands 68 contact the lower rails 98. A lower periphery of the flange 54 and edges of the stands 68 are entirely located within a profile projection of the wafer transfer cassette 22 when the handle assembly 24 is located in the position shown in FIG. 4B.

As shown in FIG. 4C, the handle assembly 24 is then moved in a direction 104 away from the wafer transfer cassette 22. A vertical spacing between a lower edge of one of the stands 68 and an upper surface of the formation 56 is less than a spacing between a lower surface of the rail supports 38 and the lower surface 46 of the lift formation 42, so as to allow for movement of the handle assembly 24 away from the wafer transfer cassette 22 without the need to lift the wafer transfer cassette 22.

The handle assembly can again be engaged and the wafer cassette be removed by following the sequence of FIGS. 4A-C in a reverse order.

It can thus be seen that the handle assembly 24 can be engaged with the wafer transfer cassette 22 without the need for lifting the wafer transfer cassette 22. The handle assembly 24 can also be used for inserting both the wafer transfer cassette 22 and the handle 24 between the rods 90 and 92. The handle assembly 24 can also be disengaged from the wafer transfer cassette 22 without the need for moving the wafer transfer cassette 22 out of its position shown in FIG. 4A.

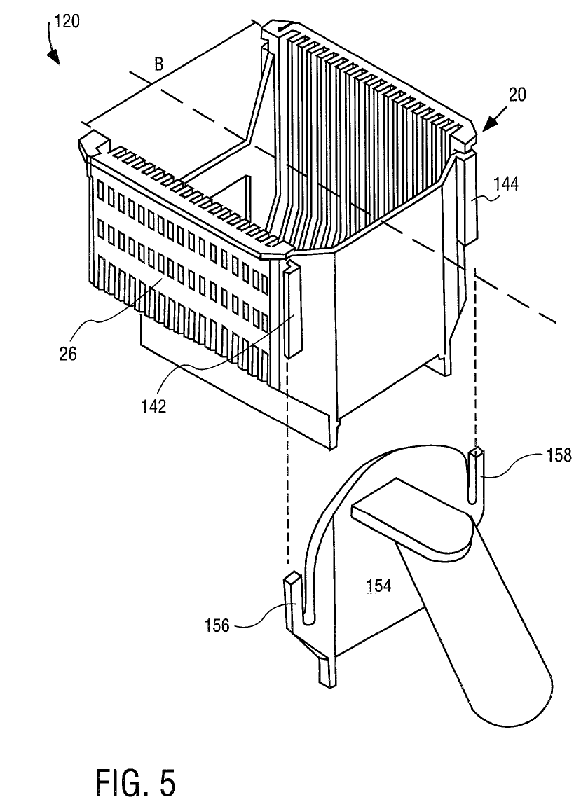

FIG. 5 illustrates an apparatus 120 for wafer transportation, according to another embodiment of the invention. The apparatus 120 is similar to the apparatus 20 shown in FIG. 1 except for the manner in which the lift formations 142 and 144 and engagement formations 156 and 158 are formed. The lift formations 142 and 144 extend away from side edges of sidewalls 26 and 28. The engagement formations 156 and 158 are slightly bent out of a plane in which a flange 154 is located. The engagement formations 156 and 158 are engageable with the lift formations 142 and 144, and then disengageable therefrom, in a manner similar as hereinbefore described with reference to FIGS. 2 and 4.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. Apparatus for wafer transportation comprising:
a wafer transfer cassette having first and second spaced sidewalls into which wafers are downwardly insertable, each wafer having a selected maximum diameter to fit between the sidewalls, a base to support lower edges of the wafers, a plurality of septa, each located between a respective pair of the wafers, and a lift structure secured to the sidewalls; and
a handle assembly including a grip, and an engaging structure secured to the grip, the engaging structure being engageable with the lift structure to allow for elevating of the transfer cassette with the grip, whereupon an upper edge of the handle assembly is below upper edges of the wafers.

2. The apparatus of claim 1 wherein the lift structure includes at least first and second spaced lift formations and the engaging structure includes a flange and first and second engaging formations on opposing sides of the flange, each engaging formation being engageable with a respective lift formation.

3. The apparatus of claim 1 wherein sliding of the engaging structure in an upward direction relative to the lift structure engages the engaging structure with the lift structure.

4. The apparatus of claim 3 wherein the handle assembly has a lower edge that is at least as high as a lower edge of the transfer cassette to allow for movement of the handle assembly towards the transfer cassette and subsequent engagement of the engaging structure with the lift structure without lifting of the transfer cassette from a supporting surface.

5. The apparatus of claim 1 wherein, when viewed in an axial direction of the wafers, the handle assembly is entirely within a projection of the wafer transfer cassette and wafers after engagement of the engaging structure with the lift structure.

6. Apparatus for wafer transportation, comprising:
a wafer transfer cassette having a lower surface for positioning on a horizontal surface, first and second spaced sidewalls to allow for inserting wafers downwardly, each wafer extending between the sidewalls and having a maximum diameter as allowed for by the spacing of the sidewalls, a base to support a lower edge of each wafer, a plurality of septa, the septa and the wafers being alternated so that a respective pair of septa support a respective wafer on opposing sides of the wafer, and a lift structure secured to the sidewalls; and
a handle assembly including a grip, and an engaging structure secured to the grip, the handle assembly having a lower surface for positioning on the horizontal surface, movement of the handle assembly towards the transfer cassette bringing the handle assembly into a preparatory position without lifting of the transfer cassette from the horizontal surface, and movement of the handle assembly in an upward direction causing sliding engagement of the engaging structure with the lift structure so that the engaging structure is then in a locked position which allows for lifting of the transfer cassette with the grip, the handle assembly being entirely within a projection of the transfer cassette and wafers when in the locked position as viewed in an axial direction of the wafers.

7. The apparatus of claim 6 wherein the wafer assembly is entirely within a projection of the transfer cassette and wafers when in the preparatory position.

8. The apparatus of claim 6 wherein the lift structure includes at least first and second spaced lift formations and the engaging structure includes a flange and first and second engaging formations on opposing sides of the flange, each engaging formation being engageable with a respective lift formation.

9. Wafer transportation apparatus, comprising:
a wafer transfer cassette including first and second opposed sidewalls spaced to allow for downwardly inserting a plurality of wafers, each wafer extending between the sidewalls and having a selected maximum diameter, a base to support lower edges of the wafers, a plurality of septa, a respective pair of which supporting opposing sides of a respective wafer, and first and second spaced apart lift formations; and
a handle assembly including a flange, a grip secured to the flange, and first and second engaging formations that sidably engage with the first and second lift formations in an upward direction to allow for elevating of the transfer cassette to an elevated position by elevating the grip, the flange being dimensioned so that an upper edge thereof is below upper edges of the wafers when the transfer cassette is elevated.

10. The wafer transportation apparatus of claim 9 wherein the handle assembly has a lower edge that is at least as high as a lower edge of the transfer cassette to allow for movement of the handle assembly towards the transfer cassette and subsequent engagement of the engaging formations with the lift formations without lifting of the transfer cassette from a supporting surface.

11. The wafer transportation apparatus of claim 9 wherein, when viewed in an axial direction of the wafers, the handle assembly is entirely within a projection of the wafer transfer cassette and wafers after engagement of the engaging formations with the lift formations.

12. Apparatus for handling a wafer, comprising:
a wafer transfer cassette having first and second spaced sidewalls into which wafer are downwardly insertable and each wafer having a selected maximum diameter to fit between the sidewalls, a base to support lower edges of the wafers, a plurality of septa, each located between a respective pair of the wafers, and a lift structure secured to the siewalls; and
a handle assembly formation including a grip, and an engaging structure secured to the grip, the engaging structure being engageable with the lift structure to allow for elevating of the transfer cassette with the grip;
a stator;
a rotor rotatably mounted to the stator and defining an enclosure having an opening for inserting the transfer cassette and the handle into the enclosure; and
a support rod secured to the rotor over upper edges of the wafers and at least a portion of the handle assembly.

13. The apparatus of claim 12 further comprising:
support rods secured to the rotor next to a respective sidewall and a respective portion to the handle assembly.

14. The apparatus of claim 12 wherein sliding of the engaging structure in an upward direction relative to the lift structure engages the engaging structure with the lift structure.

15. The apparatus of claim 12 wherein the handle assembly has a lower edge that is at least as high as a lower edge of the transfer cassette to allow for downward disengagement of the engaging structure from the lift structure and subsequent movement of the handle assembly away from the transfer cassette in an axial direction of the wafers without lifting the transfer cassette off a support surface in the rotor.
